(19) United States
(12) Patent Application Publication
(10) Pub. No.: US 2013/0221932 A1
(43) Pub. Date: Aug. 29, 2013

(54) APPARATUS AND METHOD FOR REDUCING LEAKAGE CURRENT

(71) Applicant: PANTECH CO., LTD., (US)

(72) Inventor: Sun-Wha LEE, Goyang-si (KR)

(73) Assignee: PANTECH CO., LTD., Seoul (KR)

(21) Appl. No.: 13/669,893

(22) Filed: Nov. 6, 2012

(30) Foreign Application Priority Data
Feb. 29, 2012 (KR) 10-2012-0021455

(51) Int. Cl. H02J 7/00

(52) U.S. Cl. 320/149

(57) ABSTRACT

A method for reducing leakage current generated by a pull-down circuit detects if leakage current is generated by the pull-down circuit and collects at least a portion of the leakage current. The collected leakage current is amplified and output to a battery. The apparatus to reduce leakage current includes a pull-down circuit to generate leakage current, a leakage current detector to detect the leakage current and to collect at least a portion of the leakage current, an integrator to receive leakage current and to amplify the leakage current; and a battery to receive voltage generated from the amplified leakage current.

### CROSS-REFERENCE TO RELATED APPLICATION

This application claims priority from and the benefit under 35 U.S.C. §119(a) of Korean Patent Application No. 10-2012-0021455, filed on Feb. 29, 2012, which is incorporated by reference for all purposes as if fully set forth.

### BACKGROUND

1. Field

The following description relates to an apparatus and method for reducing leakage current, and more particularly, to an apparatus and method for reducing leakage current in a pull-down resistor provided in an electronic device.

2. Discussion of the Background

In general, a circuit is included in a pad for an input and an output of a semiconductor chip included in an electronic device. The circuit has a pull-down resistor to prevent malfunction of the semiconductor chip caused by an uncertain state (high-Z) of the voltage at an internal terminal, and to reduce loss caused by an electrostatic discharge (ESD) if an internal circuit is operated in an open state.

The pull-down resistor is provided in a fixed form according the kind of pad provided to the semiconductor chip. The pull-down resistor has recently been implemented using a switching element, such as a field effect transistor (FET) that is switched on or off according to a control signal. A user controls the on/off switch of the pull-down resistor by programming the switching element according to the connection situation between semiconductor chips.

If a system is implemented, leakage current flows into the pad provided with the pull-down resistor according to an external device or internal drive value, resulting in unnecessary loss of power. In particular, the effect of leakage current is considered an important factor in a product, such as, a cellular phone, whose power consumption is an important factor in determining product competitiveness.

### SUMMARY

Exemplary embodiments of the present invention provide an apparatus and method for reducing a leakage current generated in a pull-down resistor.

Additional features of the invention will be set forth in the description which follows, and in part will be apparent from the description, or may be learned by practice of the invention.

An exemplary embodiment of the present invention discloses an apparatus to reduce leakage current, including: a pull-down circuit to generate leakage current from a received current; a leakage current detector connected to the pull down circuit to detect leakage current and to collect at least a portion of the leakage current; and an integrator to amplify the collected leakage current received from the current detector, to convert the amplified current to an output voltage, and to supply the output voltage to a battery.

An exemplary embodiment of the present invention also discloses a method for reducing leakage current in a pull-down resistor, including: detecting a leakage current generated in a pull-down resistor; collecting at least a portion of the leakage current; amplifying the collected leakage current; generating a voltage from the amplified leakage current; generating a reverse current from the voltage; and providing the reverse current to a battery.

An exemplary embodiment of the present invention also discloses a method of reducing leakage current in an electronic device, the method including: detecting a leakage current in an electronic device; collecting a portion of the leakage current; amplifying the collected leakage current; and charging a battery of the electronic device with the amplified leakage current according to a power level in the battery.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a configuration of an apparatus according to an exemplary embodiment of the present invention.

FIG. 2A is a diagram of a pull-down circuit according to an exemplary embodiment of the present invention.

FIG. 2B is a diagram of a pull-down circuit according to an exemplary embodiment of the present invention.

FIG. 3 is a diagram of an integrator according to an exemplary embodiment of the present invention.

FIG. 4 is a diagram of an integrator according to an exemplary embodiment of the present invention.

FIG. 5 is a flowchart of a method for reducing leakage current in a pull-down resistor according to an exemplary embodiment of the present invention.

### DETAILED DESCRIPTION OF THE ILLUSTRATED EMBODIMENTS

Exemplary embodiments are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Although features may be shown as separate, such features may be implanted together or individually. Further, although features may be illustrated in association with an exemplary embodiment, features for one or more exemplary embodiments may be combinable with features from one or more other exemplary embodiments.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

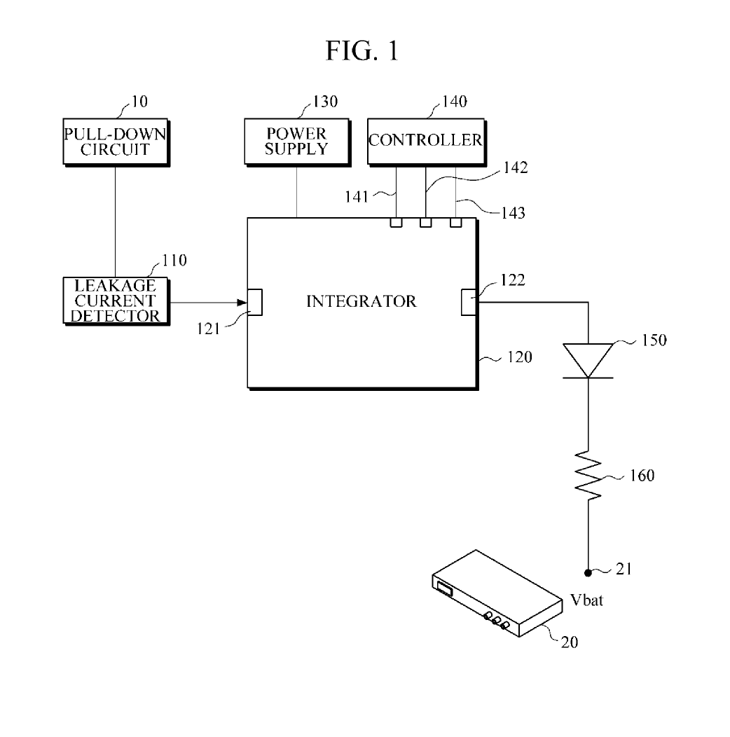

FIG. 1 is a configuration of an apparatus according to an exemplary embodiment of the present invention.

An apparatus to reduce a leakage current through a pull-down resistor (hereinafter, “apparatus”) may be included in a general device with a pull-down circuit 10. Leakage current may refer to the current lost in a circuit path, resulting in a current flowing through an alternate path in the circuit. The apparatus may be configured to receive a leakage current through the pull-down circuit 10 and to input the leaked current as a charging current of a battery 20. The apparatus includes a leakage current detector 110, an integrator 120, a power supply 130, a controller 140, a diode 150, and a resistor 160.

The pull-down circuit 10 may generate a leakage current of a few tens to a few hundreds of microampere (μA) due to a difference in potential between the pull-down circuit 10 and a ground (GND). The leakage current is a factor that may increase a current in a slip state, and may be a factor in the use of a battery of a device, such as, a cellular phone, a smart phone, a table computer, etc. The pull-down circuit of a device may be designed to include less than ten pull-down circuits.

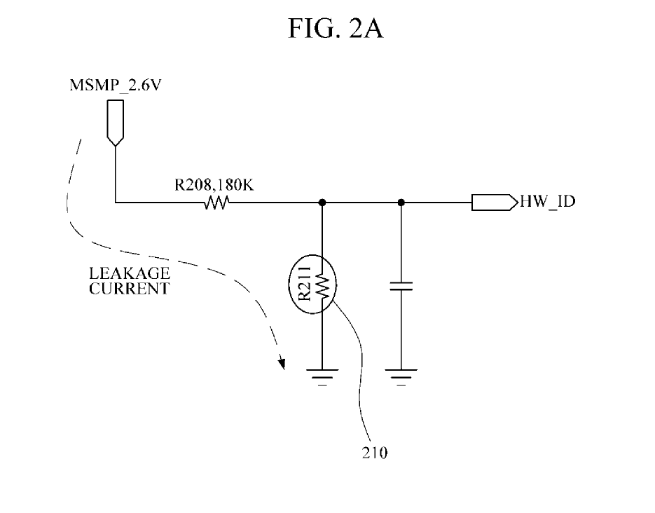

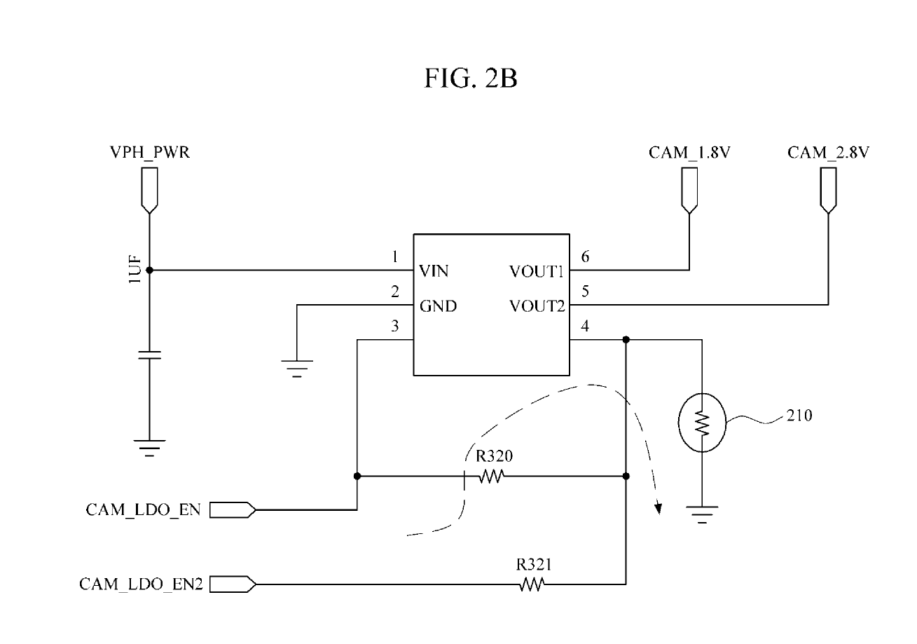

FIG. 2A is a diagram of a pull-down circuit according to an exemplary embodiment of the present invention. FIG. 2B is a diagram of a pull-down circuit according to an exemplary embodiment of the present invention. Although FIG. 2A and FIG. 2B will be described with reference to the features of FIG. 1, the exemplary embodiments are not limited thereto.

The pull-down circuit of FIG. 2A may include a Multi-Stage Multi-Path (MSMP) power source, a resistor R208, a resistor R211 or 210, a capacitor, and a second power source HD_ID. The MSMP power source may provide 2.6V to the pull-down circuit; however, aspects are not limited thereto such that the MSMP power source may provide more or less voltage, i.e., 2.6V is only an example. Referring to FIG. 2A, the current generated as a voltage and which flows through the resistor 210 may become a leakage current. Referring to FIG. 2B, the pull-down circuit may include a chip 200 with 6 pins, power source VPH_PWR connected to pin 1 of chip 200, CAM_{—}1.8V connected to pin 6 of chip 200, CAM_{—}2.8V connected to pin 5, CAM_LDO_EN connected to pin 3 of chip 200 and to pin 4 of chip 200 through resistor R320, CAM_LDO_EN2 connected to pin 3 of chip 200 and to pin 4 of chip 200 through resistor R321, a capacitor connected to power source VPH_PWR and ground, and resistor 210 connected to pin 4 of chip 200 and ground. The current generated as a voltage which flows through the resistor 210 may become a leakage current.

Referring to FIG. 1, FIG. 2A, and FIG. 2B, the leakage current detector 110 may detects a leakage current through the pull-down resistor 210. Since about 10 or more pull-down circuits may be in a device, the leakage current detector 110 may detect a leakage current from one or more pull-down circuits. This will be described in greater detail below.

Referring to FIG. 1, if power is supplied to the integrator 120 by the power supply 130, the integrator 120 may be configured to amplify a small amount of the input current as an output voltage of a reference voltage through current-to-voltage conversion. For example, the integrator 120 may perform an analog-to-digital converter (ADC) operation on a signal as an output of a reference voltage by integrating an output current of, for example, a photo-diode through which an X-ray is transmitted, and output the signal subjected to the ADC operation. The integrator 120 may be used with various electronic devices including a computed tomography (CT) Scanner data acquisition system (DAS), a photodiode sensor, an X-ray detection system, a current measurement system, etc. The integrator 120 may receive a leakage current collected by the leakage current detector 110, may amplify the received leakage current to an output voltage Vout to change a battery 20 and may output the amplified leakage current through an output terminal 122. The output voltage Vout may be higher than a charging voltage Vbat of the battery 20. In other words, if the output voltage Vout of the integrator 120 is higher than the charging voltage Vbat of the battery 20, current is generated to flow from the integrator 120 to the battery 20. For example, if the output voltage Vout is 4V and the battery 20 uses half of its capacity (about 3.7V to 3.8V), the condition of reverse current flowing from the output terminal 122 of the integrator 120 to a charging input terminal 21 of the battery 20 may be established and the battery 20 may be charged by the current.

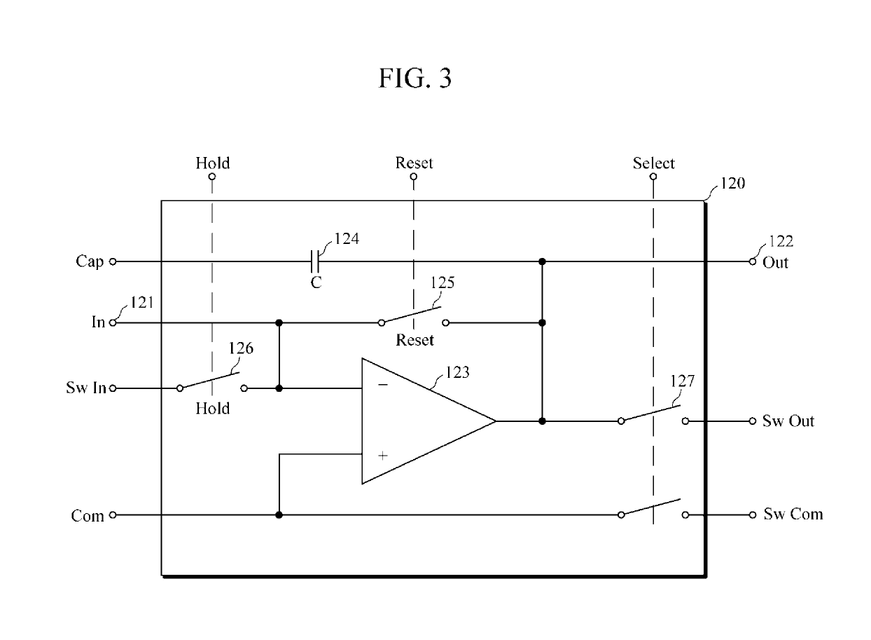

The output voltage Vout of the integrator 120 may be variably set according to a charge capacity for the battery 20. The output voltage Vout of the integrator 120 may be set by the controller 140. The controller 140 may be configured to control the integrator 120 to output the output voltage Vout according to the charge capacity of the battery 20 from the leakage current. This will be described with reference to FIG. 3.

The controller 140 may be configured to control the amount of the leakage current to be collected in the leakage current detector 110 to obtain a desired output voltage Vout. As described above, about 10 pull-down circuits may be included in a device, such as, a cellular phone, a smart phone, a table computer, a laptop computer, a personal computer, etc. Circuits configured to detect the leakage current among the plurality of pull-down circuits may be selectively controlled to obtain the output voltage Vout of the leakage current detector 110.

FIG. 3 is a diagram of an integrator according to an exemplary embodiment of the present invention. Although FIG. 3 will be described with reference to the features of FIG. 1, the exemplary embodiments are not limited thereto.

Referring to FIG. 1 and FIG. 3, the integrator 120 includes an amplifier 123 configured to amplify a current input by the leakage current detector 110 and outputs the amplified current. A hold switch 126 may be disposed between the amplifier 123 and an input terminal Sw_In through which the leakage current collected by the leakage current detector 110 may be input. The hold switch 126 may be controlled by a control signal of the controller 140. A control signal of the hold switch 126 may be input to the controller 140 through a signal line 141.

The hold switch 126 may be connected to an input line in the integrator 120 to perform an on/off function of an input. If the hold signal maintains an on-state, the input signal of the integrator 120 may be bypassed by the amplifier 123 to enter a state in which the function of an input through an input terminal In 121 can be performed. If the hold signal maintains an off-state, the input through the input terminal In 121 may not be connected to the amplifier 123 in the integrator 120 but connected to an analog GND. A reset switch 125 is disposed between an input terminal and output terminal of the amplifier 123. The reset switch 125 may be controlled by a control signal of the controller 140. A control signal of reset switch 125 may be input to the controller 140 through a signal line 142. The reset signal input by the reset switch 125 may function to transfer an integrated input signal to the output terminal Out 122. If the reset switch 125 is in an off-state, the current input from the input terminal 121 may be maintained inside of the integrator 120. The integrator 120 may be connected to the output terminal Out 122 if the reset switch 125 is maintained in an on-state, and the integrated signal charged in a capacitor 124 is transferred to the output terminal Out 122. A switch 127 may be disposed between the output terminal of the amplifier 123 and the output terminal 122. The switch 127 may be controlled by a control signal of the controller 140. The control signal for the switch 127 may be input to the controller 140 through a signal line 143.

A Cap pin and an In pin 121 of the integrator 120 may be connected on a circuit. The Cap pin and the In pin 121 may be configured to control the output voltage of the integrator 120 by adding a capacitor between the Cap pin and the In pin and an Out pin. The signal from the switch 127 functions to control the timing at which the signal is substantially output to the outside of the amplifiers 123 in integrator 120. Although only one amplifier 123 is shown in the integrator 120, aspects need not be limited thereto such that there may be more than one amplifier 123 disposed in the integrator 120.

The controller 140 may be configured to control the level of the output voltage Vout of the integrator 120 by adjusting the on/off timing of the hold switch 126 and the reset switch 125, i.e., by adjusting a time t at which the leakage current is input.

The output voltage Vout output by the integrator 120 may be represented by the is following Equation 1.

$${V}_{out} = \frac{1}{{C}_{INTEGRATION}} {\int }_{0}^{t} {I}_{IN} d t \qquad Equation 1$$

Referring to Equation 1, the output voltage Vout is inversely proportional to the capacitance C of the capacitor 124, and is obtained by integrating a leakage current input for a reference input time t.

An external capacitor may be added to the outside of the integrator 120 to control the output voltage Vout of the integrator 120.

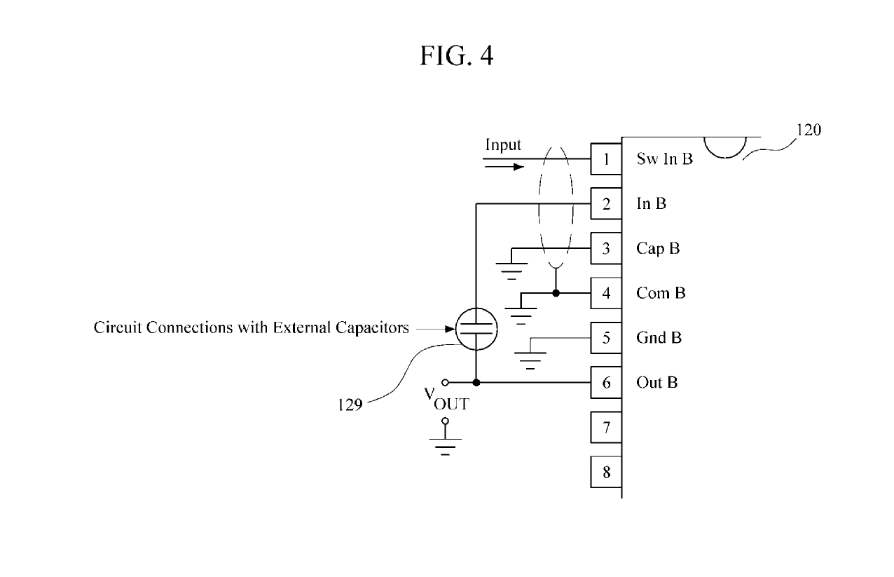

FIG. 4 is a diagram of an integrator according to an exemplary embodiment of the present invention. Although FIG. 4 will be described with reference to the features of FIG. 1, the exemplary embodiments are not limited thereto.

Referring to FIG. 4, a capacitor 129 is connected to the outside of the integrator 120. The integrator 120 may include eight pins but is not limited thereto. The value of the capacitance C in Equation 1 may be changed through the addition of the externally connected capacitor 129, the output voltage Vout of the integrator 120 may be controlled.

Referring back to FIG. 1, the diode 150 is a component that may be added to prevent a current from flowing in reverse from the battery 20 to the integrator 120.

The charging resistor 160 may be configured to allow a current to flow by the output voltage Vout output from the integrator 120, and may be connected to a charging input terminal of the battery 20. The relationship among the resistance R_{charging} of the charging resistor 160, the charging current I_{charging}, and the output voltage Vout is defined by the following Equation 2.

$${R}_{charging} = \frac{{V}_{out} - {V}_{bat}}{{I}_{charging}} \qquad Equation 2$$

The charging resistance and the output voltage may be determined in consideration of the amount of the charging current and heat generation. If the two conditions are considered, the value of the charging resistance may be experimentally measured to be about 10Ω to 30Ω.

The final current gain obtained by the apparatus is a value obtained by subtracting an input current I_{Input} for driving the integrator 120 from current I_{charging} flowing through the charging resistor, and is calculated with the following Equation 3.

$${I}_{gain} = {I}_{charging} - {I}_{Input} = \frac{{V}_{out} - {V}_{bat}}{{R}_{charging}} - {I}_{Input} \qquad Equation 3$$

For example, if the output voltage Vout of the integrator 120 is 4V, the voltage Vbat of the battery 20 is 3.6V, the resistance R_{charging} of the charging resistor is 1.5Ω, and the maximum operation current I_{Input} of the integrator 120 is 95 mA, the saved effect current is 171 mA, as calculated using the following Equation 4.

$$I = \frac{4.0 V - 3.6 V}{1.5 Ω} - 95 mA = 266 mA - 95 mA = 171 mA \qquad Equation 4$$

The 171 mA is a large enough gain to perform, for example, a camera operation in a cellular phone that may otherwise not have been possible due to insufficient battery power.

Examples of current gain according to the battery voltage are shown in the following Table 1.

TABLE 1

| | Efficiency of | Integrator | Charging | Integrator |
|---|---|---|---|---|
| Battery V | Current | output V | Resistor value | supply I |
| 4.2 | −0.228333333 | 4 | 1.5 | 0.095 |
| 4.1 | −0.161666667 | 4 | 1.5 | 0.095 |
| 4 | −0.095 | 4 | 1.5 | 0.095 |
| 3.9 | −0.028333333 | 4 | 1.5 | 0.095 |
| 3.89 | −0.021666667 | 4 | 1.5 | 0.095 |
| 3.88 | −0.015 | 4 | 1.5 | 0.095 |
| 3.87 | −0.008333333 | 4 | 1.5 | 0.095 |
| 3.86 | −0.001666667 | 4 | 1.5 | 0.095 |
| 3.85 | 0.005 | 4 | 1.5 | 0.095 |
| 3.84 | 0.01166667 | 4 | 1.5 | 0.095 |
| 3.83 | 0.018333333 | 4 | 1.5 | 0.095 |
| 3.82 | 0.25 | 4 | 1.5 | 0.095 |
| 3.81 | 0.031666667 | 4 | 1.5 | 0.095 |
| 3.8 | 0.038333333 | 4 | 1.5 | 0.095 |
| 3.7 | 0.105 | 4 | 1.5 | 0.095 |
| 3.6 | 0.171666667 | 4 | 1.5 | 0.095 |
| 3.5 | 0.238333333 | 4 | 1.5 | 0.095 |
| 3.4 | 0.305 | 4 | 1.5 | 0.095 |

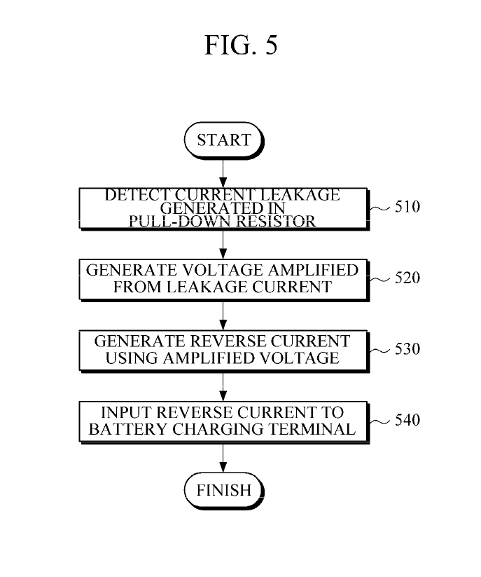

FIG. 5 is a flowchart of a method for reducing leakage current generated in a pull-down resistor according to an exemplary embodiment of the present invention. Although FIG. 5 will be described with reference to the features of FIG. 1, the exemplary embodiments are not limited thereto.

Referring to FIG. 5, in operation 510, the apparatus to reduce a leakage current may detect a leakage current through the pull-down resistor in the pull-down circuit. If ten or more pull-down circuits exist in the device, as described above, the leakage current may be detected from one or more of the pull-down circuits. The number of pull-down circuits may be determined in consideration of a voltage according to the charge capacity of the battery.

In operation 520, the apparatus amplifies an input current as an output of a reference voltage through current-to-voltage conversion of the leakage current. The input current amplified may be a small amount of the input current of the circuit. In other words, the apparatus amplifies a leakage current collected by the leakage current detector 110 as an output voltage Vout for charging the battery 20 and may output the amplified leakage current. The output voltage Vout is higher than the charging voltage Vbat of the battery 20. The output voltage Vout may be variably set according to the charge capacity of the battery.

In operation 530, the apparatus generates a reverse current using the reference voltage. In other words, the apparatus allows a voltage corresponding to the difference between the output voltage Vout and the charging voltage of the battery to flow through the charging resistor.

In operation 540, the apparatus inputs the generated reverse current to the charging terminal of the battery.

According to the exemplary embodiments, the leakage current consumed in a pull-down circuit generally used in a circuit of an electronic device may be used as a charging current of a battery using an integrator, thereby reducing the leakage current.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. An apparatus to reduce leakage current, comprising:
a pull-down circuit to generate leakage current from a received current;
a leakage current detector connected to the pull down circuit to detect leakage current and to collect at least a portion of the leakage current; and
an integrator to amplify the collected leakage current received from the current detector, to convert the amplified current to an output voltage, and to supply the output voltage to a battery.

2. The apparatus of claim 1, further comprising a diode disposed between the integrator and the battery to substantially prevent current from flowing from the battery to the integrator.

3. The apparatus of claim 1, wherein the integrator comprises:
an amplifier to amplify the collected leakage current;
a first switch to connect the integrator to the leakage current detector; and
wherein if the leakage current detector detects the leakage current the first switch connects the integrator to the leakage current detector and the amplifier amplifies the collected leakage current from the leakage current detector.

4. The apparatus of claim 3, wherein the integrator further comprises:
a capacitor to store the amplified collected leakage current; and
a second switch to connect the integrator to the battery,
wherein the capacitor stores the amplified current from the amplifier; and the second switch connects the integrator to the battery to output the voltage stored in the capacitor.

5. The apparatus of claim 1, further comprising a controller to control the integrator and the leakage current detector.

6. The apparatus of claim 5, further comprising a power supply to supply power to the integrator, wherein the integrator amplifies the power received from the power supply.

7. The apparatus of claim 1, wherein the apparatus is used in at least one of a smart phone, a cellular phone, a smart phone, a table computer, a laptop computer, a personal computer, a computed tomography scanner data acquisition system, an X-ray detection system, and a current measurement system.

8. The apparatus of claim 5, wherein the controller controls the amount of amplified current generated by the integrator according to a capacitance of the battery.

9. The apparatus of claim 5, wherein the controller controls the amount of leakage current collected by the leakage current detector according to a capacitance of the battery.

10. A method for reducing leakage current in a pull-down resistor, comprising:
detecting a leakage current generated in a pull-down resistor;
collecting at least a portion of the leakage current;
amplifying the collected leakage current;
generating a voltage from the amplified leakage current;
generating a reverse current from the voltage; and
providing the reverse current to a battery.

11. The method of claim 10, further comprising preventing a backflow of current from the battery.

12. The method of claim 10, wherein the generated the reverse current from the voltage is generated according to the capacitance of the battery.

13. The method of claim 10, wherein the collected leakage current is collected according to the capacitance of the battery.

14. The method of claim 12, wherein generating the reverse current from the voltage is generated according to the capacitance of the battery comprises:
detecting a capacitance level in the battery;
controlling a capacitor to provide a charging current to the battery according to the capacitance level of the battery.

15. The method of claim 10, further comprising:
receiving a current from a power supply if the leakage current is not collected;
amplifying the received current; and
generating the voltage from the amplified current;
generating the reverse current from the voltage; and
providing the reverse current to the battery.

16. A method of reducing leakage current in an electronic device, the method comprising:
detecting a leakage current in an electronic device;
collecting a portion of the leakage current;
amplifying the collected leakage current; and
charging a battery of the electronic device with the amplified leakage current according to a power level in the battery.

17. The method of claim 16, wherein detecting a leakage current comprises:
detecting a current received in a pull-down circuit.

18. The method of claim 16, wherein charging the battery with the amplified leakage current according to a power level in a battery of the electronic device comprises:
detecting a capacitance level in a battery;
charging a capacitor with the amplified leakage current; and
controlling the capacitor to provide a charging current according to the capacitance level of the battery.

19. The method of claim 16, wherein the electronic device is at least one of a smart phone, a cellular phone, a smart phone, a table computer, a laptop computer, a personal computer, a computed tomography scanner data acquisition system, an X-ray detection system, and a current measurement system.

20. The method of claim 16, further comprising:
receiving a current from a power supply if the leakage current is not collected;
amplifying the received current; and
charging the battery according to the power level in the battery.
